(19) United States
(12) Patent Application Publication
(10) Pub. No.: US 2024/0097833 A1
(43) Pub. Date: Mar. 21, 2024

(54) HYBRID AUTOMATIC REPEAT REQUEST ACKNOWLEDGMENT GENERATION TECHNIQUES FOR GROUP COMMON SHARED CHANNELS

(71) Applicant: ZTE Corporation, Shenzhen (CN)

(72) Inventors: Xiaolong GUO, Shenzhen (CN); Wei GOU, Shenzhen (CN); Jing SHI, Shenzhen, Guangdong (CN); Xing LIU, Shenzhen (CN); Peng HAO, Shenzhen (CN); Xingguang WEI, Shenzhen (CN)

(21) Appl. No.: 18/524,798

(22) Filed: Nov. 30, 2023

Related U.S. Application Data
(63) Continuation of application No. PCT/CN2021/141929, filed on Dec. 28, 2021.

(51) Int. Cl. H04L 1/1829; H04W 72/232; H04W 72/30

(52) U.S. Cl. CPC H04L 1/1861; H04W 72/232; H04W 72/30

(57) ABSTRACT

Techniques are described for hybrid automatic repeat request acknowledgement (HARQ-ACK) information generation techniques for group common shared channels, such as one or more physical downlink shared channels (PDSCHs). A wireless communication method includes receiving, by a communication device, a control information that indicates that a set of information is to be received by the communication device using a multicast service; and transmitting, by the communication device, HARQ ACK information in a shared channel, where the HARQ-ACK information indicates whether the set of information is received or correctly decoded by the communication device, where the HARQ-ACK information is generated using assignment indexes included in the control information received by the communication device, where each of the assignment indexes indicates a size of the HARQ-ACK information to be transmitted by the communication device, and where the assignment indexes are associated with the multicast service and a unicast service.

### CROSS-REFERENCE TO RELATED APPLICATION

This application is a continuation and claims priority to International Application No. PCT/CN2021/141929, filed on Dec. 28, 2021, the disclosure of which is hereby incorporated by reference herein in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for hybrid automatic repeat request acknowledgement (HARQ-ACK) information generation techniques for group common shared channels, such as physical downlink shared channels (PDSCHs).

A first exemplary wireless communication method includes receiving, by a communication device, a control information that indicates that a set of information is to be received by the communication device using a multicast service; and transmitting, by the communication device, hybrid automatic repeat request (HARM) acknowledgement (ACK) information in a shared channel, where the HARQ-ACK information indicates whether the set of information is received or correctly decoded by the communication device, where the HARQ-ACK information is generated using assignment indexes included in the control information received by the communication device, where each of the assignment indexes indicates a size of the HARQ-ACK information to be transmitted by the communication device, and where the assignment indexes are associated with the multicast service and a unicast service.

In some embodiments, the set of information includes unicast information and multicast information that are respectively scheduled by a unicast control information and a multicast control information, the assignment indexes include a first assignment index for the unicast service and a second assignment index for the unicast service, the assignment indexes include a third assignment index for the multicast service and a fourth assignment index for the multicast service, the first assignment index and the second assignment index are associated with the unicast control information scrambled with a cell radio network temporary identifier (C-RNTI), each of the third assignment index and the fourth assignment index is associated with the multicast control information scrambled with one group radio network temporary identifier (G-RNTI) group, and the one G-RNTI group includes one or more G-RNTIs.

In some embodiments, the set of information includes a first set of multicast information and a second set of multicast information that are respectively scheduled by the first multicast control information and the second multicast control information, the assignment indexes include a first assignment index for the multicast service and a second assignment index for the multicast service, the first assignment index is associated with a first multicast control information that is scrambled with a first set of one or more group radio temporary identifiers (G-RNTIs) from a first G-RNTI group, and the second assignment index is associated with a second multicast control information that is scrambled with a second set of one or more G-RNTIs from a second G-RNTI group. In some embodiments, the communication device receives a radio resource control (RRC) signal that configures one or more G-RNTI groups, wherein each G-RNTI group includes a unique set of one or more G-RNTIs.

In some embodiments, the set of information includes unicast information that is scheduled by a unicast control information, the set of information includes multicast information that is scheduled by a first multicast control information and a second multicast control information, the assignment indexes include a first assignment index that is shared by the unicast service and the multicast service and a second assignment index for the multicast service, the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and the second assignment index is associated or shared with the unicast control information scrambled with the C-RNTI and with the second multicast control information scrambled with a second set of one or more G-RNTIs from a second G-RNTI group. In some embodiments, a value of an assignment index from the assignment indexes is equal to mod(max(Xᵣₙₜᵢ)−1,4)+1, where Xᵣₙₜᵢ is a number of pairs of serving cell and control channel monitoring occasion for a corresponding RNTI.

In some embodiments, a value of an assignment index from the assignment indexes is equal to max(V_{T-DAI}^{rnti}), where V_{T-DAI}^{rnti} is a value of an assignment index in a last downlink control information (DCI) which indicates to provide feedback in a slot for the corresponding RNTI. In some embodiments, a value of an assignment index from the assignment indexes is equal to an integer from 1 to 4. In some embodiments, the unicast control information includes a downlink control information (DCI) for the unicast service.

A second exemplary wireless communication method includes receiving, by a communication device, a control information that indicates that a set of information is to be received by the communication device using a multicast service; and transmitting, by the communication device, hybrid automatic repeat request (HARQ) acknowledgement (ACK) information in a shared channel, where the HARQ-ACK information indicates whether the set of information is received or correctly decoded by the communication device, where the HARQ-ACK information is generated using assignment indexes included in the control information received by the communication device, where a number of the assignment indexes indicates a size of the HARQ-ACK information, where the set of information includes multiple sets of multicast information scheduled by one or more multicast control information received by the communication device, and where the one or more multicast control information is scrambled with one set of one or more group radio network temporary identifiers (G-RNTIs) included in the one or more G-RNTI groups.

In some embodiments, the HARQ information includes one sub-codebook for each G-RNTI group that include one or more G-RNTIs. In some embodiments, the set of information includes at least one set of multicast information scheduled by at least one multicast control information scrambled with a second set of one or more G-RNTIs that are not included in the one or more G-RNTI groups, and the communication device generates the HARQ information to include a second set of sub-codebooks for the second set of one or more G-RNTIs using a default assignment index value. In some embodiments, the multicast control information, the first multicast control information, the second multicast control information, the one or more multicast control information, or at least one multicast control information includes at least one downlink control information (DCI) for the multicast service. In some embodiments, the shared channel includes a physical uplink shared channel (PUSCH), the control information includes a downlink control information (DCI), and the assignment indexes include uplink (UL) downlink assignment indexes (DAIs). In some embodiments, the set of information is to be received by the communication device using one or more physical downlink shared channels (PDSCHs).

A third exemplary wireless communication method includes transmitting, by a network device, a control information that indicates that a set of information is to be transmitted to a communication device using a multicast service; and receiving, by the network device, hybrid automatic repeat request (HARQ) acknowledgement (ACK) information in a shared channel, where the HARQ-ACK information indicates whether the set of information is received or correctly decoded by the communication device, where the HARQ-ACK information is based on assignment indexes included in the control information transmitted to the communication device, where each of the assignment indexes indicates a size of the HARQ-ACK information to be received from the communication device, and where the assignment indexes are associated with the multicast service and a unicast service.

In some embodiments, the set of information includes unicast information and multicast information that are respectively scheduled by a unicast control information and a multicast control information, the assignment indexes include a first assignment index for the unicast service and a second assignment index for the unicast service, the assignment indexes include a third assignment index for the multicast service and a fourth assignment index for the multicast service, the first assignment index and the second assignment index are associated with the unicast control information scrambled with a cell radio network temporary identifier (C-RNTI), each of the third assignment index and the fourth assignment index is associated with the multicast control information scrambled with one group radio network temporary identifier (G-RNTI) group, and the one G-RNTI group includes one or more G-RNTIs. In some embodiments, the set of information includes a first set of multicast information and a second set of multicast information that are respectively scheduled by the first multicast control information and the second multicast control information, the assignment indexes include a first assignment index for the multicast service and a second assignment index for the multicast service, the first assignment index is associated with a first multicast control information that is scrambled with a first set of one or more group radio temporary identifiers (G-RNTIs) from a first G-RNTI group, and the second assignment index is associated with a second multicast control information that is scrambled with a second set of one or more G-RNTIs from a second G-RNTI group.

In some embodiments, the network device transmits a radio resource control (RRC) signal that configures one or more G-RNTI groups, wherein each G-RNTI group includes a unique set of one or more G-RNTIs. In some embodiments, the set of information includes unicast information that is scheduled by a unicast control information, the set of information includes multicast information that is scheduled by a first multicast control information and a second multicast control information, the assignment indexes include a first assignment index that is shared by the unicast service and the multicast service and a second assignment index for the multicast service, the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and the second assignment index is associated or shared with the unicast control information scrambled with the C-RNTI and with the second multicast control information scrambled with a second set of one or more G-RNTIs from a second G-RNTI group.

In some embodiments, a value of an assignment index from the assignment indexes is equal to mod(max(Xᵣₙₜᵢ)−1,4)+1, where Xᵣₙₜᵢ is a number of pairs of serving cell and control channel monitoring occasion for a corresponding RNTI. In some embodiments, a value of an assignment index from the assignment indexes is equal to max(V_{T-DAI}^{rnti}), where V_{T-DAI}^{rnti} is a value of an assignment index in a last downlink control information (DCI) which indicates to provide feedback in a slot for the corresponding RNTI. In some embodiments, a value of an assignment index from the assignment indexes is equal to an integer from 1 to 4. In some embodiments, the unicast control information includes a downlink control information (DCI) for the unicast service.

A fourth exemplary wireless communication method includes transmitting, by a network device, a control information that indicates that a set of information is to be transmitted to a communication device using a multicast service; and receiving, by the communication device, hybrid automatic repeat request (HARQ) acknowledgement (ACK) information in a shared channel, where the HARQ-ACK information indicates whether the set of information is received or correctly decoded by the communication device, where the HARQ-ACK information is based on assignment indexes included in the control information received by the communication device, where a number of the assignment indexes indicates a size of the HARQ-ACK information, where the set of information includes multiple sets of multicast information scheduled by one or more multicast control information received by the communication device, and where the one or more multicast control information is scrambled with one set of one or more group radio network temporary identifiers (G-RNTIs) included in the one or more G-RNTI groups.

In some embodiments, the HARQ information includes one sub-codebook for each G-RNTI group that include one or more G-RNTIs. In some embodiments, the set of information includes at least one set of multicast information scheduled by at least one multicast control information scrambled with a second set of one or more G-RNTIs that are not included in the one or more G-RNTI groups, and the HARQ information includes a second set of sub-codebooks for the second set of one or more G-RNTIs using a default assignment index value. In some embodiments, the multicast control information, the first multicast control information, the second multicast control information, the one or more multicast control information, or at least one multicast control information includes at least one downlink control information (DCI) for the multicast service. In some embodiments, the shared channel includes a physical uplink shared channel (PUSCH), the control information includes a downlink control information (DCI), and the assignment indexes include uplink (UL) downlink assignment indexes (DAIs). In some embodiments, the set of information is to be transmitted to the communication device using one or more physical downlink shared channels (PDSCHs).

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a first exemplary flowchart for transmitting a HARQ-ACK information in a shared channel.

FIG. 2 shows a second exemplary flowchart for transmitting a HARQ-ACK information in a shared channel.

FIG. 3 shows a first exemplary flowchart for receiving a HARQ-ACK information in a shared channel.

FIG. 4 shows a second exemplary flowchart for receiving a HARQ-ACK information in a shared channel.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

Acknowledgement (ACK) or non-acknowledgement (NACK) based hybrid automatic repeat request acknowledgement (HARQ-ACK) feedback is applied for unicast and it may be supported for multicast. A multicast may include a base station transmitting multiple services to multiple UEs using a group common DCI. Type-1 codebook and Type-2 codebook are both supported for unicast and multicast. Type-1 codebook may be referred to as semi-static codebook and Type-2 codebook may be referred to as dynamic codebook. Type-1 codebook is generated semi-statically according to the set of M_{A,C} occasions for candidate physical downlink shared channel (PDSCH) receptions which is determined based on several RRC configurations. Type-2 codebook is generated based on downlink assignment index (DAI) in DCI formats for scheduling of PDSCH, the description of DAI (including counter DAI and total DAI) and codebook generation can be found in clause 9 in NR TS 38.213. A PDSCH is scheduled by a downlink (DL) DCI, in which counter DAI (C-DAI) and total DAI (T-DAI) can be included. C-DAI is the counting number (or counter) of PDSCHs received by UE, and T-DAI is the total number of PDSCHs. For single carrier scenario, these two values can be the same. For carrier aggregation (CA) cases, T-DAI can be different from C-DAI.

A UE may receive the DAI field that can also be included in DCI formats for scheduling of PUSCH, where the DAI field may include an uplink (UL) DAI value. The UL DAI value can indicate a number of PDSCHs that the UE can expect to receive. When HARQ-ACK information is transmitted on PUSCH by the UE, UL DAI can be utilized by the UE to generate codebooks with correct codebook size, so that data transmission in PUSCH will not be affected. In unicast, DCI format 0_0 does not include DAI field, but DCI format 0_1 and 0_2 can include 1 or 2 UL DAI fields which are called 1^{st} DAI and 2^{nd} DAI respectively. When HARQ-ACK information for multicast is to be multiplexed in PUSCH, UL DAI should also be applied or indicated to the UE (e.g., using radio resource control (RRC) signaling) so that UE can obtain the correct codebook size if DCI missing cases happen, where for example, the UE does not receive the DCI.

Type-2 codebook generation for unicast when transmitted in PUCCH and PUSCH can be the same, which is based on the pseudo-code in clause 9.1.3 in TS 38.213. The difference is that if a UE multiplexes HARQ-ACK information in a PUSCH transmission that is scheduled by a DCI format that includes a DAI field, after the completion of the c and m loops, the UE sets Vₜₑₘₚ₂=V_{T-DAI}^{UL}, where V_{T-DAI}^{UL} is the value of the DAI field. Type-2 sub-codebook generation for each group radio network temporary identifier (G-RNTI) can reuse the pseudo-code for unicast.

For unicast, DCI format is scrambled by cell radio network temporary identifier (C-RNTI); and for multicast, DCI format is scrambled by G-RNTI. When a UE receives information transmitted by the base station using multicast, the UE may receive multiple DCI formats, where each DCI format is scrambled with one G-RNTI, and DCI formats are scrambled with the same G-RNTI belong to a same multicast service. Type-2 codebook for multicast is the concatenation of a plurality of sub-codebooks for the plurality of G-RNTIs in G-RNTI ascending order, where each sub-codebook can be associated with one G-RNTI. DAI counting is performed in DL DCI per G-RNTI, one UL DAI field for each G-RNTI is needed when UL DAI is specific for each G-RNTI. Base station can assign the DAI value in DL scheduling DCIs, where the DAI value can be in cycles of 4, e.g., if 5 PDSCHs are scheduled, then the corresponding DAI will be assigned to be 1,2,3,4,1, which is referred to as DAI counting. The overhead for UL DAI in DCI format will be quite large with the growing of the number of G-RNTIs, which might not be acceptable. Mechanism of applying UL DAI to multicast using less additional overhead or using the existing fields should be introduced.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Embodiment 1

The embodiment is to apply UL DAI to Type-2 sub-codebook generation for multicast when transmitted in PUSCH. The value of UL DAI is shared by multiple services, including unicast services and multicast services, the description and usage of the UL DAI can be consistent with those for unicast in the current technology. The embodiment can be realized by the following cases.

In one example, if a UE receives 3 DCIs (and 3 PDSCHs), the DAI value can be 1, 2, and 3, respectively. The UE will first generate the codebook with 3 bits, and when UL DAI in DCI scheduling PUSCH is 3, the codebook may not be changed. If the UL DAI is a value other than 3, then redundant NACK bits can be added at the end of the codebook above to satisfy the following equation: [(the final codebook size)mod 4=UL DAI]. For example, when UL DAI is 1, then 2 NACK value can be added at the end so that final codebook size is 5, (5 mod 4=1) is satisfied.

Case 1:

In Case 1, the one or more UL DAI fields for unicast is separately indicated from the one or more UL DAI fields for multicast. One or more UL DAI field(s) for unicast in DCI formats is not changed, the value is represented by V_{T-DAI}^{UL}, codebook generation and transmission in PUSCH for unicast can stay the same as what is described in the current technology. Type-2 codebook generation for unicast is based on the pseudo-code in clause 9.1.3 in TS 38.213, after the completion of the c and m loops, Vₜₑₘₚ₂ is assigned to be the value of T-DAI in the last DCI scheduling PDSCHs which are indicated in the same codebook, then UE sets Vₜₑₘₚ₂=V_{T-DAI}^{UL} and obtain the total number of HARQ-ACK bits.

UL DAI for multicast is additionally configured in DCI formats, the value is also represented by V_{T-DAI}^{UL}, Type-2 sub-codebook generation for each G-RNTI when transmitted in PUSCH is based on pseudo-code for unicast, after the completion of the c and m loops, UE sets Vₜₑₘₚ₂=V_{T-DAI}^{UL} and obtain the total number of HARQ-ACK bits. For the convenience of illustration, assume up to 2 UL DAI fields for multicast can be included in DCI formats.

When two G-RNTI groups are configured for a UE using, for example, RRC signaling received by the UE, UL DAI field (e.g., in the DCI) for multicast contains 1^{st} DAI and 2^{nd} DAI, where 1^{st} DAI is applied for G-RNTIs in the 1^{st} G-RNTI group, and where 2^{nd} DAI is applied for G-RNTIs in the 2^{nd} G-RNTI group. When the number of sub-codebooks for received G-RNTIs is not equal to the number of G-RNTIs in the G-RNTI group, UE can generate all NACK value in the sub-codebook for the G-RNTI(s) that is/are not received. The codebook size is equal to the value of the corresponding UL DAI. The number of G-RNTIs can be configured by the base station and indicated to the UE using RRC signaling.

When only one (1) G-RNTI group is configured, UL DAI field for multicast contains 1^{st} DAI and it is applied for G-RNTIs in the G-RNTI group. The other G-RNTIs which are not included in the G-RNTI group will utilize a default number as UL DAI to generate sub-codebooks. When the number of sub-codebooks for received G-RNTIs is not equal to the number of G-RNTIs in the G-RNTI group or no PDSCHs for one G-RNTI which is not in the G-RNTI group are received, UE generates all NACK value in the sub-codebook for the G-RNTI(s) which is not received, the codebook size is equal to the value of UL DAI or the default number.

When no G-RNTI group is configured, all G-RNTIs will utilize a default number as UL DAI to generate sub-codebooks. When no PDSCHs for one G-RNTI are received, UE generates all NACK value in the sub-codebook for the G-RNTI, the codebook size is equal to the default number.

Case 2:

In Case 2, unicast and multicast share the UL DAI field so that only one or two UL DAI field value(s) is indicated by the base station to the UE. UL DAI field for unicast in DCI formats is not changed, the value is represented by V_{T-DAI}^{UL}, codebook generation and transmission in PUSCH for unicast can stay the same as what is described in the current technology. Type-2 codebook generation for unicast is based on the pseudo-code in clause 9.1.3 in TS 38.213, after the completion of the c and m loops, Vₜₑₘₚ₂ is assigned to be the value of T-DAI in the last DCI scheduling PDSCHs which are indicated in the same codebook, then UE sets Vₜₑₘₚ₂=V_{T-DAI}^{UL} and obtain the total number of HARQ-ACK bits.

UL DAI field for unicast is shared with multicast, the value is still represented by V_{T-DAI}^{UL}, Type-2 sub-codebook generation for each G-RNTI when transmitted in PUSCH is based on pseudo-code for unicast, after the completion of the c and m loops, UE sets Vₜₑₘₚ₂=V_{T-DAI}^{UL} and obtain the total number of HARQ-ACK bits. For the convenience of illustration, assume up to 2 UL DAI fields for multicast can be included in DCI formats.

If PUSCH is scheduled by the DCI in which only 1^{st} DAI is included, UE does not expect more than one G-RNTI groups are configured, 1^{st} DAI is applied for G-RNTIs in the first G-RNTI group, a default number is applied for G-RNTIs which are not in the G-RNTI group. When no G-RNTI groups are configured, a default number is applied for all G-RNTIs, the UL DAI is only applied to PDSCHs scrambled by C-RNTI.

If PUSCH is scheduled by the DCI in which 1^{st} DAI and 2^{nd} DAI are included, when two G-RNTI groups are configured, 1^{st} DAI is applied for G-RNTIs in the first G-RNTI group, 2^{nd} DAI is applied for G-RNTIs in the second G-RNTI group. When one G-RNTI group is configured, 1^{st} DAI is applied for G-RNTIs in the G-RNTI group, a default number is applied for G-RNTIs which are not included in the G-RNTI group. When no G-RNTI groups are configured, a default number is applied for all G-RNTIs, the UL DAI is only applied to PDSCHs scrambled by C-RNTI.

When the number of sub-codebooks for received G-RNTIs is not equal to the number of G-RNTIs in the G-RNTI group or no PDSCHs for one G-RNTI which is not in the G-RNTI group are received, UE generates all NACK value in the sub-codebook for the G-RNTI(s) which is not received, the codebook size is equal to the value of UL DAI or the default number.

### II. Embodiment 2

The embodiment is to configure G-RNTI groups which mentioned in Embodiment 1, the configuration is by RRC signalling or DCI indication. For the convenience of illustration, assume up to 2 G-RNTI groups can be configured.

Method 1: RRC Signalling

Case 1: When G-RNTI groups are configured by UE-specific RRC signalling, the base station can indicate the values in the parenthesis to the UE as shown below so that the UE can determine how many G-RNTI groups are configured and how the UE is expected to process the one or more received G-RNTIs:
The base station can indicate to the UE (1-1) if 2 G-RNTI groups are configured, all G-RNTIs which received by UE are divided into the groups, the group can contain one or more G-RNTIs;
The base station can indicate to the UE (1-2) if 2 G-RNTI groups are configured, UE does not expect any G-RNTIs received by UE are not included in the 2 G-RNTI groups;
The base station can indicate to the UE (1-3) if 2 G-RNTI groups are configured; for any G-RNTI received by UE that the UE determines is not included in the 2 G-RNTI groups, a default number can be applied by the UE as UL DAI for the G-RNTI.
The base station can indicate to the UE (2-1) if 1 G-RNTI group is configured, the group can contain one or more G-RNTIs;
The base station can indicate to the UE (2-2) if 1 G-RNTI group is configured, any G-RNTI received by UE that the UE determines is not included in the 1 G-RNTI group, a default number can be applied by the UE as UL DAI for the G-RNTI.
The base station can indicate to the UE (3-1) if no G-RNTI groups are configured, DAI field in DCI scheduling PUSCH is invalid for codebook generation for multicast.

Case 2: when G-RNTI groups are configured by group RRC signalling, the base station can indicate the values in the parenthesis to the UE as shown below so that the UE can determine how many G-RNTI groups are configured and how the UE is expected to process the one or more received G-RNTIs:
The base station can indicate to the UE (1-1) if 2 G-RNTI groups are configured, all G-RNTIs which transmitted by gNB are divided into the groups, the group can contain one or more G-RNTIs;
The base station can indicate to the UE (1-2) if 2 G-RNTI groups are configured, UE does not expect any G-RNTIs received by UE that are not included in the 2 G-RNTI groups;
The base station can indicate to the UE (1-3) if 2 G-RNTI groups are configured, any G-RNTI received by UE that the UE determines is not included in the 2 G-RNTI groups, a default number can be applied by the UE as UL DAI for the G-RNTI.
The base station can indicate to the UE (1-4) if 2 G-RNTI groups are configured, UE will not generate Type-2 codebook for G-RNTIs which are in the group but not reported or interested to receive by UE.
The base station can indicate to the UE (2-1) if 1 G-RNTI group is configured, the group can contain one or more G-RNTIs;
The base station can indicate to the UE (2-2) if 1 G-RNTI group is configured, any G-RNTI received by UE that the UE determines is not included in the 1 G-RNTI group, a default number can be applied by the UE as UL DAI for the G-RNTI.
The base station can indicate to the UE (2-3) if 1 G-RNTI groups is configured, UE will not generate Type-2 codebook for G-RNTIs which are in the group but not reported or interested to receive by UE.
The base station can indicate to the UE (3-1) if no G-RNTI groups are configured, DAI field in DCI scheduling PUSCH is invalid for codebook generation for multicast.

Method 2: DCI Indication

Case 1:

A new indication field is introduced in downlink DCI scheduling GC-PDSCHs, 1 bit is needed under the assumption in this embodiment. When the value of the indication field is 0, the corresponding G-RNTI is indicated to the 1^{st} G-RNTI group, when the value of indication field is 1, the corresponding G-RNTI is indicated to the second G-RNTI group, when the indication field is not included in the DCI, the corresponding G-RNTI does not belong to any G-RNTI groups.

Case 2:

Existing fields in DL DCI can be reused to indicate the G-RNTI group. Take the following examples, the value of C-DAI and T-DAI are always the same in single carrier scenarios, as for now Carrier Aggregation(CA) is not supported for multicast, T-DAI is not necessary for DCIs scheduling GC-PDSCHs, T-DAI field can be reused. Multicast HARQ-ACK information will be multiplexed in PUSCH when overlapping, PRI field can be reused as PUCCH will not be transmitted.

### III. Embodiment 3

The embodiment is to make rules for setting the value of UL DAI, which may be needed when applying the Embodiment 1. The value range of UL DAI can be 1 to 4.

Case 1:

The value of UL DAI is set by the base station to be mod(max(Xᵣₙₜᵢ)−1,4)+1, Xᵣₙₜᵢ is the number of {serving cell, PDCCH monitoring occasion}-pair(s) for the corresponding rnti, if rnti is C-RNTI, the pairs include PDSCH transmission(s) associated with PDCCH or PDCCH indicating semi-persistent scheduling (SPS) PDSCH release or DCI format 1_1 indicating SCell dormancy is present, if rnti is G-RNTI, the pairs include PDSCH transmission(s) associated with GC-PDCCH.

Case 2:

The value of UL DAI is set by the base station to be max(V_{T-DAI}^{rnti}), V_{T-DAI}^{rnti} is the value of T-DAI in the last DCI which indicates to provide feedback in the slot for the corresponding rnti, the last DCI refers to the last DCI transmitted by gNB, not the last DCI received by UE.

Case 3:

Network (or base station) assigns any number to the UL DAI which in the scope of 1 to 4.

### IV. Embodiment 4

The embodiment is for Type-2 codebook generation for multicast SPS when transmitted in PUCCH/PUSCH. For now, only 1 bit will be generated in Type-2 codebook for multicast SPS, no need to apply the embodiment 1 to generate the codebook based on UL DAI.

Case 1:

For each group configured scheduled radio network temporary identifier (G-CS-RNTI), sub-codebook will be generated with only 1 bit, and it will be concatenated after sub-codebooks for G-RNTI. Multiple sub-codebooks for G-CS-RNTI will be concatenated in G-CS-RNTI ascending order.

Case 2:

For each G-CS-RNTI, sub-codebook will be generated with only 1 bit, concatenation of sub-codebooks for G-RNTI and G-CS-RNTI are in ascending order of the value of G-RNTI and G-CS-RNTI.

Case 3:

If there is one-to-one correspondence between G-CS-RNTI and G-RNTI, DAI counting is applied for the corresponding G-RNTI and G-CS-RNTI together, one sub-codebook will be generated for them based on the DAI value in the DL DCI, sub-codebook generation when transmitting in PUSCH can apply the embodiment 1.

### V. Embodiment 5

The embodiment is to apply UL DAI to Type-2 sub-codebook generation for multicast when transmitted in PUSCH, the value of UL DAI is the sum of the number of {serving cell, PDCCH monitoring occasion}-pair(s) for multiple services, including unicast services and multicast services. The embodiment can be realized by the following cases.

Case 1:

UL DAI field for unicast in DCI formats is not changed, the value is represented by V_{T-DAI}^{UL}, codebook generation and transmission in PUSCH for unicast can stay the same as what is described in the current technology. Type-2 codebook generation for unicast is based on the pseudo-code in clause 9.1.3 in TS 38.213, after the completion of the c and m loops, Vₜₑₘₚ₂ is assigned to be the value of T-DAI in the last DCI scheduling PDSCHs which are indicated in the same codebook, then UE sets Vₜₑₘₚ₂=V_{T-DAI}^{UL} and obtain the total number of HARQ-ACK bits.

UL DAI for multicast is additionally configured in DCI formats, the value is also represented by V_{T-DAI}^{UL}, Type-2 sub-codebook generation for each G-RNTI when transmitted in PUSCH is based on pseudo-code for unicast, after the completion of the c and m loops, UE does not set Vₜₑₘₚ₂=V_{T-DAI}^{UL} and obtain the total number of HARQ-ACK bits as HARQ-ACK is transmitted in PUCCH. For the convenience of illustration, assume up to 2 UL DAI fields for multicast can be included in DCI formats.

When two G-RNTI groups are configured, UL DAI field for multicast contains 1^{st} DAI and 2^{nd} DAI, 1^{st} DAI is applied for G-RNTIs in the 1^{st} G-RNTI group, 2^{nd} DAI is applied for G-RNTIs in the 2^{nd} G-RNTI group. After generating sub-codebooks for all G-RNTIs in the group, if mod(ΣO_{ACK}^{G-RNTI}−1,4)+1≠V_{T-DAI}^{UL}, O_{ACK}^{G-RNTI} is the obtained codebook size for one G-RNTI, U NACK information bits will be added at the end of the codebook to make mod(ΣO_{ACK}^{G-RNTI}−1,4)+1=V_{T-DAI}^{UL}.

When only 1 G-RNTI group is configured, UL DAI field for multicast contains 1^{st} DAI and it is applied for G-RNTIs in the G-RNTI group. The other G-RNTIs which are not included in the G-RNTI group will utilize a default number as UL DAI to generate sub-codebooks.

In the above cases, if U NACK information bits are added, all HARQ-ACK bits in sub-codebooks for G-RNTIs in the group will be set to NACK, for the reason that UE can not position the missing DCI if it is the last DCI.

When no G-RNTI group is configured, all G-RNTIs will utilize a default number as UL DAI to generate sub-codebooks. When no PDSCHs for one G-RNTI are received, UE generates all NACK value in the sub-codebook for the G-RNTI, the codebook size is equal to the default number.

Case 2:

UL DAI field for unicast in DCI formats is not changed, the value is represented by V_{T-DAI}^{UL}, no additional UL DAI fields for multicast are introduced. UL DAI fields are used for both C-RNTI and G-RNTI. Type-2 sub-codebook generation for C-RNTI and G-RNTI is based on pseudo-code for unicast when transmitting in PUCCH. After the completion of the c and m loops, UE does not set Vₜₑₘₚ₂=V_{T-DAI}^{UL} and obtain the total number of HARQ-ACK bits. For the convenience of illustration, assume up to 2 UL DAI fields for multicast can be included in DCI formats.

If PUSCH is scheduled by the DCI in which only 1^{st} DAI is included, UE does not expect more than one G-RNTI groups are configured. When one G-RNTI group is configured, 1^{st} DAI is applied for G-RNTIs in the G-RNTI group, a default number is applied for G-RNTIs which are not included in the G-RNTI group. When no G-RNTI groups are configured, a default number is applied for all G-RNTIs, the UL DAI is only applied to PDSCHs scrambled by C-RNTI.

If PUSCH is scheduled by the DCI in which 1^{st} DAI and 2^{nd} DAI are included, when two G-RNTI groups are configured, 1^{st} DAI is applied for G-RNTIs in the first G-RNTI group, 2^{nd} DAI is applied for G-RNTIs in the second G-RNTI group. When one G-RNTI group is configured, 1st DAI is applied for G-RNTIs in the G-RNTI group, a default number is applied for G-RNTIs which are not included in the G-RNTI group. When no G-RNTI groups are configured, a default number is applied for all G-RNTIs, the UL DAI is only applied to PDSCHs scrambled by C-RNTI.

After generating sub-codebooks for all G-RNTIs in the group, if mod(ΣO_{ACK}^{G-RNTI}−1,4)+1≠V_{T-DAI}^{UL}, O_{ACK}^{G-RNTI} is the obtained codebook size for one G-RNTI or C-RNTI, U NACK information bits will be added at the end of the codebook to make mod(ΣO_{ACK}^{G-RNTI}−1,4)+1=V_{T-DAI}^{UL}.

### VI. Embodiment 6

The embodiment is to redefine UL DAI and generate codebooks using one specific value configured by RRC signalling, UL DAI indicates the number of services which generate codebooks using the specific value. The specific value is called auxiliary DAI hereinafter in this embodiment, the range of value is 1 to 4.

Case 1:

UL DAI field for unicast in DCI formats is not changed, the value is represented by V_{T-DAI}^{UL}, UL DAI for multicast is additionally configured in DCI formats. Codebook generation and transmission in PUSCH for unicast can stay the same as what described in the current technology. Sub-codebooks generation for multicast when transmitted in PUSCH is related to the auxiliary DAI. In this embodiment, assume up to 2 UL DAI filed for multicast can be configured in DCI formats, 0 if no multicast services are scheduled, 1 if RRC configures one auxiliary DAI value, 2 if RRC configures two auxiliary DAI value. When 2 UL DAI field for multicast is included in DCI, the former G-RNTIs which the total number is the first UL DAI value generate sub-codebooks using the first auxiliary DAI, the latter G-RNTIs which the total number is the second UL DAI value generate sub-codebooks using the second auxiliary DAI. When 1 UL DAI field for multicast is included in DCI, the former G-RNTIs which the total number is the first UL DAI value generate sub-codebooks using the auxiliary DAI, the other G-RNTIs generate sub-codebooks using a default number.

For unicast, Type-2 codebook generation is based on the pseudo-code in clause 9.1.3 in TS 38.213, after the completion of the c and m loops, UE sets Vₜₑₘₚ₂=V_{T-DAI}^{UL} and obtain the total number of HARQ-ACK bits.

For multicast, Type-2 sub-codebook for each G-RNTI is generated based on the pseudo-code for unicast, after the completion of the c and m loops, UE sets Vₜₑₘₚ₂=V_{auxiliary-DAI}^{UL} and obtain the total number of HARQ-ACK bits. The sub-codebooks are concatenated in G-RNTI ascending order. The size of each sub-codebook is the same when j in the pseudo-code equals to each other, otherwise, the size differs by a multiple of 4.

When the number of sub-codebooks for received G-RNTIs is not equal to the corresponding UL DAI value, UE will generate all NACK value for the missing sub-codebook, the codebook size equals to the corresponding auxiliary DAI value.

Case 2:

UL DAI field for unicast in DCI formats are not changed, do not introduce additional UL DAI field for multicast. Codebook generation for unicast and sub-codebooks generation for multicast when transmitted in PUSCH is related to the auxiliary DAI when configured, otherwise codebook generation for unicast is consistent with the current mechanism and UE does not expect to transmit HARQ-ACK information for multicast in PUSCH.

If RRC configures one auxiliary DAI value or only 1^{st} DAI field is configured in DCI formats. For unicast, Type-2 codebook generation is based on the pseudo-code in clause 9.1.3 in TS 38.213, after the completion of the c and m loops, UE sets Vₜₑₘₚ₂=V_{auxiliary-DAI}^{UL} and obtain the total number of HARQ-ACK bits. For multicast, Type-2 sub-codebook for each G-RNTI is generated based on the pseudo-code for unicast, after the completion of the c and m loops, UE sets Vₜₑₘₚ₂=V_{auxiliary-DAI}^{UL} and obtain the total number of HARQ-ACK bits. The sub-codebooks are concatenated in G-RNTI ascending order.

If RRC configures two auxiliary DAI value and 1^{st} and 2^{nd} DAI field are both configured in DCI formats. For unicast, Type-2 codebook generation is based on the pseudo-code in clause 9.1.3 in TS 38.213, after the completion of the c and m loops, UE sets Vₜₑₘₚ₂=V₁_{^{st}} _{auxiliary-DAI}^{UL} and obtain the total number of HARQ-ACK bits. For multicast, the former G-RNTIs which the total number is the first UL DAI value generate sub-codebooks using the first auxiliary DAI, the latter G-RNTIs which the total number is the second UL DAI value generate sub-codebooks using the second auxiliary DAI. Type-2 sub-codebook for each G-RNTI is generated based on the pseudo-code for unicast, after the completion of the c and m loops, UE sets Vₜₑₘₚ₂=V_{auxiliary-DAI}^{UL} and obtain the total number of HARQ-ACK bits. The sub-codebooks are concatenated in G-RNTI ascending order.

When the number of sub-codebooks for received G-RNTIs is not equal to the corresponding UL DAI value, UE will generate all NACK value for the missing sub-codebook, the codebook size equals to the corresponding auxiliary DAI value.

### VII. Embodiment 7

The techniques described for embodiment 7 may include performing DAI counting for G-RNTIs which are configured to be the G-RNTI group, additional UL DAI fields are included in DCI for each G-RNTI group. The zero or more additional UL DAI fields for multicast can be included in DCI scheduling PUSCHs so that the zero or more additional UL DAI values in the zero or more UL DAI fields can be set by the base station, where each additional UL DAI field is associated with one G-RNTI group. For the convenience of illustration, assume up to 2 G-RNTI groups can be configured in some embodiments.

0 UL DAI field for multicast if no multicast services are scheduled, 1 UL DAI field if RRC configures one G-RNTI group, 2 UL DAI fields if RRC configures two G-RNTI groups. The value of UL DAI is represented by V_{T-DAI}^{UL}.

For G-RNTIs in the configured group, sub-codebooks are generated together similarly as sub-codebook for one G-RNTI. Type-2 codebook generation is based on the pseudo-code in clause 9.1.3 in TS 38.213, all PDSCHs associated with PDCCHs which are scrambled by G-RNTIs in the same group will be counted, not counted per G-RNTI, after the completion of the c and m loops, UE sets Vₜₑₘₚ₂=V_{T-DAI}^{UL} and obtain the total number of HARQ-ACK bits.

For G-RNTIs which are not in the group, sub-codebooks are generated per G-RNTI utilizing a default number as UL DAI. After the completion of the c and m loops in the pseudo-code, UE sets Vₜₑₘₚ₂=V_{default} and obtain the total number of HARQ-ACK bits.

### VIII Embodiment 8

The embodiment provides some rules for multiplexing between multiple NACK-only PUCCHs.

(1) Multiplexing Methods

For now, the following are 2 potential workable methods for NACK-only multiplexing, method 1, define up to [A] orthogonal PUCCH resources to select from according to combinations of up to [B] TBs with NACK-only feedback, values for A and B are not defined in the currently technology. Method 2, NACK-only feedback is transformed into ACK/NACK based, i.e., the UE reports HARQ-ACK as in Rel-16 if the UE is provided UE-specific PUCCH resources. It is not clear which to choose or how to make the mechanism work well. The following rules can be performed:

When more than one NACK-only feedback are available for transmission in the same PUCCH slot,
for up to [B] TBs for one G-RNTI with NACK-only feedback, define up to [A] orthogonal PUCCH resources to select from;
for more than [B] TBs for one G-RNTI with NACK-only feedback, NACK-only feedback is transformed into ACK/NACK based;
for any TBs for multiple G-RNTIs with NACK-only feedback, NACK-only feedback is transformed into ACK/NACK based.
[A] orthogonal PUCCH resources are defined per G-RNTI, when PUCCH resources for more than 1 G-RNTI exist in the same slot, NACK-only feedback of all TBs is transformed into ACK/NACK based.

(2) Orthogonal PUCCH Resources Description

For up to [B] TBs for one G-RNTI with NACK-only feedback, up to [A] orthogonal PUCCH resources should be defined, A can be equal to 2\hat{ }B or 2\hat{ }B-1. As orthogonal PUCCH resources are configured by RRC, and scheduled TBs which are indicated to provide NACK-only feedback differs in each slot, the value of A should be configurable in the scope of {4,8,16}.
RRC configures one monitoring occasion window, and configures the value of A according to the number of PDCCHs which possibly exist in the monitoring occasion window, i.e. A is configured to be 4,8,16 when the number of possible PDCCHs are 2, 3, 4, respectively.
RRC configures the value of A according to TDD-UL-DL-configuration in frame structure, e.g. when it is configured to be DDDSU, A is configured to be 8, i.e. 2\hat{ }(N_{DLslot}).

### IX. Embodiment 9

The embodiment is to define UE behavior when generating Type-2 codebook for PDSCHs scheduled by DCI format 1_0 and HARQ-ACK enabling/disabling is configured to be indicated by DCI, HARQ-ACK enabling/disabling indication field is not included in DCI format 1_0.

Case 1:

HARQ-ACK feedback for PDSCHs scheduled by DCI format 1_0 is always enabling, DAI, PRI and K1 are valid in DCI format 1_0, Type-2 codebook includes HARQ-ACK information of these PDSCHs.

Case 2:

When PDSCHs, in the same Type-2 sub-codebook for one G-RNTI, are scheduled by both DCI format 1_1 and 1_0, when all DCI format 1_1 indicate HARQ-ACK disabling(or enabling), HARQ-ACK feedback for PDSCHs scheduled by DCI format 1_0 is also disabling(or enabling).

Case 3:

When PDSCHs, in the same Type-2 sub-codebook for one G-RNTI, are all scheduled by DCI format 1_0, HARQ-ACK feedback for PDSCHs scheduled by DCI format 1_0 is enabling by default, Type-2 codebook includes HARQ-ACK information of these PDSCHs.

### CONCLUSION

This section describes some example methods and techniques of HARQ-ACK information generation for group common PDSCHs as described in this patent document:

Embodiment 1 may include applying UL DAI to Type-2 sub-codebook generation for multicast when transmitted in PUSCH, the value of UL DAI is shared by multiple services, including unicast services and multicast services, the description and usage of the UL DAI can be consistent with those for unicast in the current technology.

Additional UL DAI fields can be included in DCI format.
1^{st} and 2^{nd} DAI field for unicast in DCI format can be shared for C-RNTI and G-RNTI.
Each UL DI field is for one G-RNTI group.

Embodiment 2 may include configuring G-RNTI groups which mentioned in Embodiment 1, the configuration is by RRC signalling or DCI indication.
RRC signalling can be UE-specific or group-common
DCI indication can introduce new fields or reuse the existing field.

Embodiment 3 may include making rules for setting the value of UL DAI, which is necessary when applying the embodiment 1. The value range of UL DAI is still 1 to 4.
mod(max(Xᵣₙₜᵢ)−1,4)+1, Xᵣₙₜᵢ is the number of {serving cell, PDCCH monitoring occasion}-pair(s) for the corresponding rnti.
max(V_{T-DAI}^{rnti}), V_{T-DAI}^{rnti} is the value of T-DAI in the last DCI which indicates to provide feedback in the slot for the corresponding rnti.
Any number in the scope of 1 to 4.

Embodiment 4 may include Type-2 codebook generation for multicast SPS when transmitted in PUCCH/PUSCH. For now, only 1 bit will be generated in Type-2 codebook for multicast SPS, no need to apply the embodiment 1 to generate the codebook based on UL DAI.
Sub-codebook for each G-CS-RNTI is concatenated after sub-codebooks for G-RNTI. Multiple sub-codebooks for G-CS-RNTI will be concatenated in G-CS-RNTI ascending order.
Concatenation of sub-codebooks for G-RNTI and G-CS-RNTI are in ascending order of the value of G-RNTI and G-CS-RNTI.
If there is one-to-one correspondence between G-CS-RNTI and G-RNTI, DAI counting is applied for the corresponding G-RNTI and G-CS-RNTI together, one joint sub-codebook will be generated.

Embodiment 5 may include applying UL DAI to Type-2 sub-codebook generation for multicast when transmitted in PUSCH, the value of UL DAI is the sum of the number of {serving cell, PDCCH monitoring occasion}-pair(s) for multiple services, including unicast services and multicast services.
Additional UL DAI fields can be included in DCI format.
1^{st} and 2^{nd} DAI field for unicast in DCI format can be shared for C-RNTI and G-RNTI.
Each UL DI field is for one G-RNTI group.

Embodiment 6 may include redefining UL DAI and generate codebooks using one specific value configured by RRC signalling, UL DAI indicates the number of services which generate codebooks using the specific value. The specific value is called auxiliary DAI hereinafter in this embodiment, the range of value is 1 to 4.
Additional UL DAI fields can be included in DCI format. One auxiliary DAI is configured for each UL DAI field.
Codebook generation for unicast and sub-codebooks generation for multicast when transmitted in PUSCH is related to the auxiliary DAI when configured.

Embodiment 7 may include performing DAI counting for G-RNTIs which are configured to be the G-RNTI group, additional UL DAI fields are included in DCI for each G-RNTI group. For G-RNTIs in the configured group, sub-codebooks are generated together similarly as sub-codebook for one G-RNTI. For G-RNTIs which are not in the group, sub-codebooks are generated per G-RNTI utilizing a default number as UL DAI.

Embodiment 8 may include providing some rules for multiplexing between multiple NACK-only PUCCHs.
(1) multiplexing methods—when more than one NACK-only feedback are available for transmission in the same PUCCH slot, determine different multiplexing methods according to scheduled TBs.
(2) orthogonal PUCCH resources description—for up to [B] TBs for one G-RNTI with NACK-only feedback, up to [A] orthogonal PUCCH resources should be defined, the value of A should be configurable in the scope of {4,8,16} according to the number of PDCCHs which possibly exist in the monitoring occasion window or TDD-UL-DL-configuration in frame structure.

Embodiment 9 may include defining UE behavior when generating Type-2 codebook for PDSCHs scheduled by DCI format 1_0 and HARQ-ACK enabling/disabling is configured to be indicated by DCI, HARQ-ACK enabling/disabling indication field is not included in DCI format 1_0.
always enabling
follow HARQ-ACK enabling/disabling indication in DCI format 1_1
enabling by default when no DCI format 1_1 exist

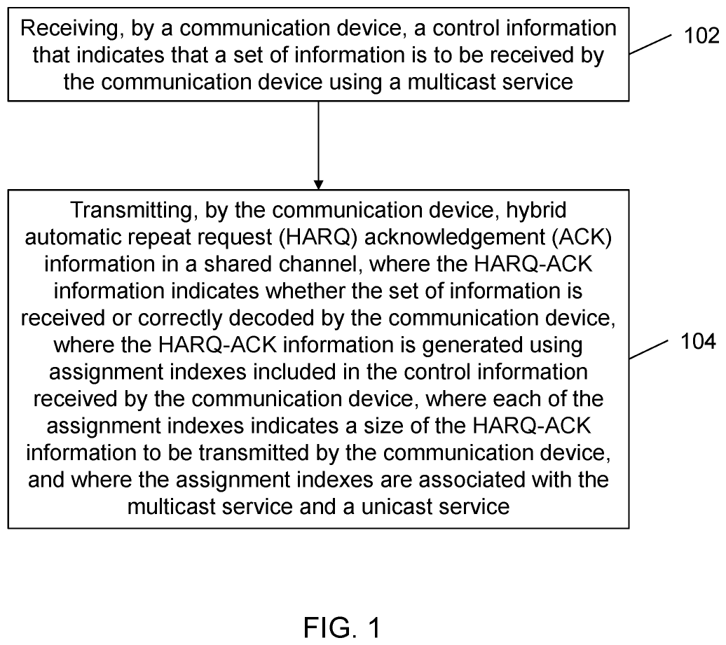

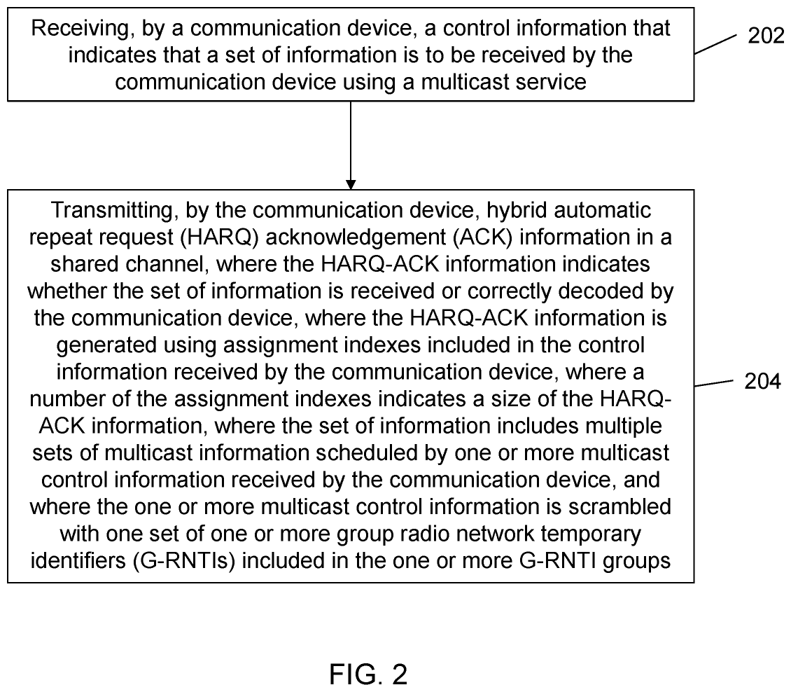

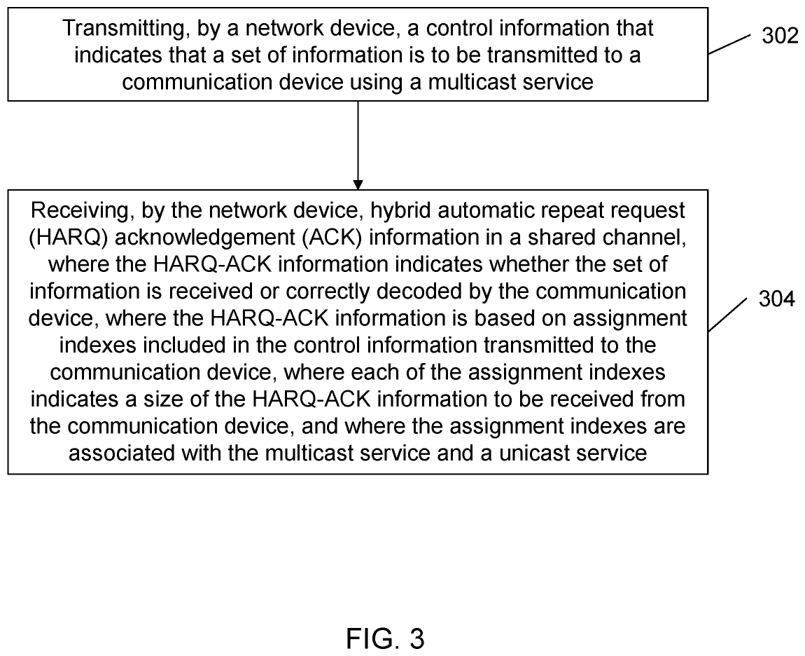

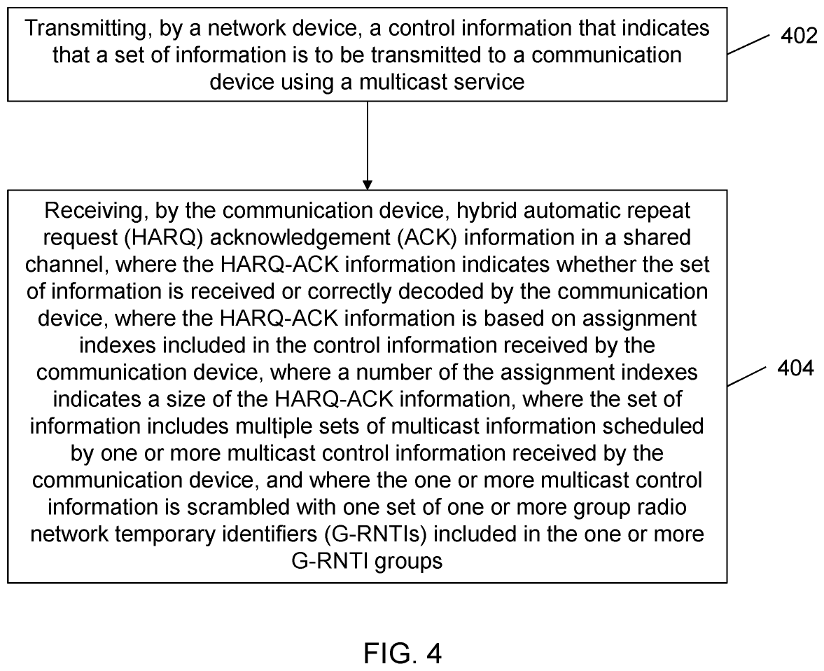

FIGS. 1 and 3 describe techniques that are at least described in Embodiments 1 to 3 of this patent document. FIGS. 2 and 4 describe techniques that are at least described in Embodiment 7 of this patent document.

FIG. 1 shows a first exemplary flowchart for transmitting a HARQ-ACK information in a shared channel. Operation 102 includes receiving, by a communication device, a control information that indicates that a set of information is to be received by the communication device using a multicast service. Operation 104 includes transmitting, by the communication device, hybrid automatic repeat request (HARD) acknowledgement (ACK) information in a shared channel, where the HARQ-ACK information indicates whether the set of information is received or correctly decoded by the communication device, where the HARQ-ACK information is generated using assignment indexes included in the control information received by the communication device, where each of the assignment indexes indicates a size of the HARQ-ACK information to be transmitted by the communication device, and where the assignment indexes are associated with the multicast service and a unicast service. In some embodiments, the size of the HARQ-ACK information can be determined based on the assignment indexes.

In some embodiments, the set of information includes unicast information and multicast information that are respectively scheduled by a unicast control information and a multicast control information, the assignment indexes include a first assignment index for the unicast service and a second assignment index for the unicast service, the assignment indexes include a third assignment index for the multicast service and a fourth assignment index for the multicast service, the first assignment index and the second assignment index are associated with the unicast control information scrambled with a cell radio network temporary identifier (C-RNTI), each of the third assignment index and the fourth assignment index is associated with the multicast control information scrambled with one group radio network temporary identifier (G-RNTI) group, and the one G-RNTI group includes one or more G-RNTIs.

In some embodiments, the set of information includes a first set of multicast information and a second set of multicast information that are respectively scheduled by the first multicast control information and the second multicast control information, the assignment indexes include a first assignment index for the multicast service and a second assignment index for the multicast service, the first assignment index is associated with a first multicast control information that is scrambled with a first set of one or more group radio temporary identifiers (G-RNTIs) from a first G-RNTI group, and the second assignment index is associated with a second multicast control information that is scrambled with a second set of one or more G-RNTIs from a second G-RNTI group. In some embodiments, the communication device receives a radio resource control (RRC) signal that configures one or more G-RNTI groups, wherein each G-RNTI group includes a unique set of one or more G-RNTIs.

In some embodiments, the set of information includes unicast information that is scheduled by a unicast control information, the set of information includes multicast information that is scheduled by a first multicast control information and a second multicast control information, the assignment indexes include a first assignment index that is shared by the unicast service and the multicast service and a second assignment index for the multicast service, the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and the second assignment index is associated or shared with the unicast control information scrambled with the C-RNTI and with the second multicast control information scrambled with a second set of one or more G-RNTIs from a second G-RNTI group. In some embodiments, a value of an assignment index from the assignment indexes is equal to mod(max(Xᵣₙₜᵢ)−1,4)+1, where Xᵣₙₜᵢ is a number of pairs of serving cell and control channel monitoring occasion for a corresponding RNTI.

In some embodiments, a value of an assignment index from the assignment indexes is equal to max(V_{T-DAI}^{rnti}), where V_{T-DAI}^{rnti} is a value of an assignment index in a last downlink control information (DCI) which indicates to provide feedback in a slot for the corresponding RNTI. In some embodiments, a value of an assignment index from the assignment indexes is equal to an integer from 1 to 4. In some embodiments, the unicast control information includes a downlink control information (DCI) for the unicast service.

FIG. 2 shows a second exemplary flowchart for transmitting a HARQ-ACK information in a shared channel. Operation 202 includes receiving, by a communication device, a control information that indicates that a set of information is to be received by the communication device using a multicast service. Operation 204 includes transmitting, by the communication device, hybrid automatic repeat request (HARQ) acknowledgement (ACK) information in a shared channel, where the HARQ-ACK information indicates whether the set of information is received or correctly decoded by the communication device, where the HARQ-ACK information is generated using assignment indexes included in the control information received by the communication device, where a number of the assignment indexes indicates a size of the HARQ-ACK information, where the set of information includes multiple sets of multicast information scheduled by one or more multicast control information received by the communication device, and where the one or more multicast control information is scrambled with one set of one or more group radio network temporary identifiers (G-RNTIs) included in the one or more G-RNTI groups.

In some embodiments, the HARQ information includes one sub-codebook for each G-RNTI group that include one or more G-RNTIs. In some embodiments, the set of information includes at least one set of multicast information scheduled by at least one multicast control information scrambled with a second set of one or more G-RNTIs that are not included in the one or more G-RNTI groups, and the communication device generates the HARQ information to include a second set of sub-codebooks for the second set of one or more G-RNTIs using a default assignment index value. In some embodiments, the multicast control information, the first multicast control information, the second multicast control information, the one or more multicast control information, or at least one multicast control information includes at least one downlink control information (DCI) for the multicast service. In some embodiments, the shared channel includes a physical uplink shared channel (PUSCH), the control information includes a downlink control information (DCI), and the assignment indexes include uplink (UL) downlink assignment indexes (DAIs). In some embodiments, the set of information is to be received by the communication device using one or more physical downlink shared channels (PDSCHs).

FIG. 3 shows a first exemplary flowchart for receiving a HARQ-ACK information in a shared channel. Operation 302 includes transmitting, by a network device, a control information that indicates that a set of information is to be transmitted to a communication device using a multicast service. Operation 304 includes receiving, by the network device, hybrid automatic repeat request (HARD) acknowledgement (ACK) information in a shared channel, where the HARQ-ACK information indicates whether the set of information is received or correctly decoded by the communication device, where the HARQ-ACK information is based on assignment indexes included in the control information transmitted to the communication device, where each of the assignment indexes indicates a size of the HARQ-ACK information to be received from the communication device, and where the assignment indexes are associated with the multicast service and a unicast service.

In some embodiments, the set of information includes unicast information and multicast information that are respectively scheduled by a unicast control information and a multicast control information, the assignment indexes include a first assignment index for the unicast service and a second assignment index for the unicast service, the assignment indexes include a third assignment index for the multicast service and a fourth assignment index for the multicast service, the first assignment index and the second assignment index are associated with the unicast control information scrambled with a cell radio network temporary identifier (C-RNTI), each of the third assignment index and the fourth assignment index is associated with the multicast control information scrambled with one group radio network temporary identifier (G-RNTI) group, and the one G-RNTI group includes one or more G-RNTIs. In some embodiments, the set of information includes a first set of multicast information and a second set of multicast information that are respectively scheduled by the first multicast control information and the second multicast control information, the assignment indexes include a first assignment index for the multicast service and a second assignment index for the multicast service, the first assignment index is associated with a first multicast control information that is scrambled with a first set of one or more group radio temporary identifiers (G-RNTIs) from a first G-RNTI group, and the second assignment index is associated with a second multicast control information that is scrambled with a second set of one or more G-RNTIs from a second G-RNTI group.

In some embodiments, the network device transmits a radio resource control (RRC) signal that configures one or more G-RNTI groups, wherein each G-RNTI group includes a unique set of one or more G-RNTIs. In some embodiments, the set of information includes unicast information that is scheduled by a unicast control information, the set of information includes multicast information that is scheduled by a first multicast control information and a second multicast control information, the assignment indexes include a first assignment index that is shared by the unicast service and the multicast service and a second assignment index for the multicast service, the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and the second assignment index is associated or shared with the unicast control information scrambled with the C-RNTI and with the second multicast control information scrambled with a second set of one or more G-RNTIs from a second G-RNTI group.

In some embodiments, a value of an assignment index from the assignment indexes is equal to mod(max(Xᵣₙₜᵢ)−1,4)+1, where Xᵣₙₜᵢ is a number of pairs of serving cell and control channel monitoring occasion for a corresponding RNTI. In some embodiments, a value of an assignment index from the assignment indexes is equal to max(V_{T-DAI}^{rnti}), where V_{T-DAI}^{rnti} is a value of an assignment index in a last downlink control information (DCI) which indicates to provide feedback in a slot for the corresponding RNTI. In some embodiments, a value of an assignment index from the assignment indexes is equal to an integer from 1 to 4. In some embodiments, the unicast control information includes a downlink control information (DCI) for the unicast service.

FIG. 4 shows a second exemplary flowchart for receiving a HARQ-ACK information in a shared channel. Operation 402 includes transmitting, by a network device, a control information that indicates that a set of information is to be transmitted to a communication device using a multicast service. Operation 404 includes receiving, by the communication device, hybrid automatic repeat request (HARQ) acknowledgement (ACK) information in a shared channel, where the HARQ-ACK information indicates whether the set of information is received or correctly decoded by the communication device, where the HARQ-ACK information is based on assignment indexes included in the control information received by the communication device, where a number of the assignment indexes indicates a size of the HARQ-ACK information, where the set of information includes multiple sets of multicast information scheduled by one or more multicast control information received by the communication device, and where the one or more multicast control information is scrambled with one set of one or more group radio network temporary identifiers (G-RNTIs) included in the one or more G-RNTI groups.

In some embodiments, the HARQ information includes one sub-codebook for each G-RNTI group that include one or more G-RNTIs. In some embodiments, the set of information includes at least one set of multicast information scheduled by at least one multicast control information scrambled with a second set of one or more G-RNTIs that are not included in the one or more G-RNTI groups, and the HARQ information includes a second set of sub-codebooks for the second set of one or more G-RNTIs using a default assignment index value. In some embodiments, the multicast control information, the first multicast control information, the second multicast control information, the one or more multicast control information, or at least one multicast control information includes at least one downlink control information (DCI) for the multicast service. In some embodiments, the shared channel includes a physical uplink shared channel (PUSCH), the control information includes a downlink control information (DCI), and the assignment indexes include uplink (UL) downlink assignment indexes (DAIs). In some embodiments, the set of information is to be transmitted to the communication device using one or more physical downlink shared channels (PDSCHs).

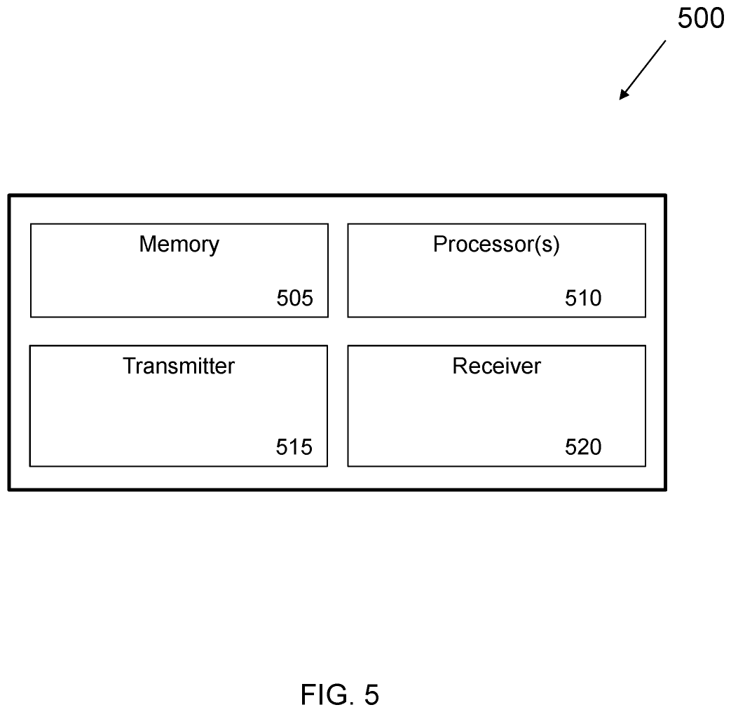

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

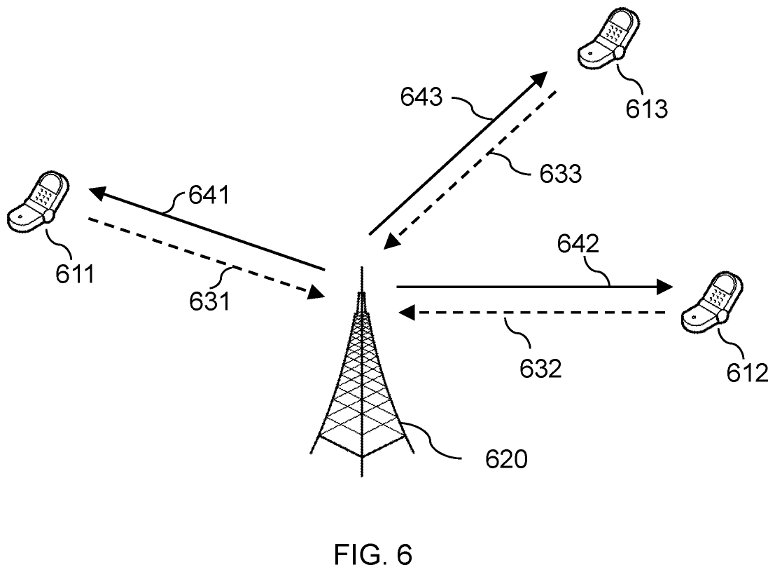

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
receiving, by a communication device, a control information that indicates that a set of information is to be received by the communication device using a multicast service; and
transmitting, by the communication device, hybrid automatic repeat request (HARM) acknowledgement (ACK) information in a shared channel,
wherein the HARQ-ACK information indicates whether the set of information is received or correctly decoded by the communication device,
wherein the HARQ-ACK information is generated using assignment indexes included in the control information received by the communication device,
wherein each of the assignment indexes indicates a size of the HARQ-ACK information to be transmitted by the communication device, and
wherein the assignment indexes are associated with the multicast service and a unicast service.

2. The method of claim 1,
wherein the set of information includes unicast information and multicast information that are respectively scheduled by a unicast control information and a multicast control information,
wherein the assignment indexes include a first assignment index for the unicast service and a second assignment index for the unicast service,
wherein the assignment indexes include a third assignment index for the multicast service and a fourth assignment index for the multicast service,
wherein the first assignment index and the second assignment index are associated with the unicast control information scrambled with a cell radio network temporary identifier (C-RNTI),
wherein each of the third assignment index and the fourth assignment index is associated with the multicast control information scrambled with one group radio network temporary identifier (G-RNTI) group, and
wherein the one G-RNTI group includes one or more G-RNTIs.

3. The method of claim 1,
wherein the set of information includes a first set of multicast information and a second set of multicast information that are respectively scheduled by the first multicast control information and the second multicast control information,
wherein the assignment indexes include a first assignment index for the multicast service and a second assignment index for the multicast service,
wherein the first assignment index is associated with a first multicast control information that is scrambled with a first set of one or more group radio temporary identifiers (G-RNTIs) from a first G-RNTI group, and
wherein the second assignment index is associated with a second multicast control information that is scrambled with a second set of one or more G-RNTIs from a second G-RNTI group.

4. The method of claim 2, wherein the communication device receives a radio resource control (RRC) signal that configures one or more G-RNTI groups, wherein each G-RNTI group includes a unique set of one or more G-RNTIs.

5. The method of claim 1,
wherein the set of information includes unicast information that is scheduled by a unicast control information,
wherein the set of information includes multicast information that is scheduled by a first multicast control information and a second multicast control information,
wherein the assignment indexes include a first assignment index that is shared by the unicast service and the multicast service and a second assignment index for the multicast service,
wherein the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and
wherein the second assignment index is associated or shared with the unicast control information scrambled with the C-RNTI and with the second multicast control information scrambled with a second set of one or more G-RNTIs from a second G-RNTI group.

6. The method of claim 1,
wherein a value of an assignment index from the assignment indexes is equal to mod(max(Xᵣₙₜᵢ)−1,4)+1,
wherein Xᵣₙₜᵢ is a number of pairs of serving cell and control channel monitoring occasion for a corresponding RNTI.

7. The method of claim 1,
wherein a value of an assignment index from the assignment indexes is equal to max(V_{T-DAI}^{rnti}),
wherein V_{T-DAI}^{rnti} is a value of an assignment index in a last downlink control information (DCI) which indicates to provide feedback in a slot for the corresponding RNTI.

8. A wireless communication method, comprising:
transmitting, by a network device, a control information that indicates that a set of information is to be transmitted to a communication device using a multicast service; and
receiving, by the network device, hybrid automatic repeat request (HARQ) acknowledgement (ACK) information in a shared channel,
wherein the HARQ-ACK information indicates whether the set of information is received or correctly decoded by the communication device,
wherein the HARQ-ACK information is based on assignment indexes included in the control information transmitted to the communication device,
wherein each of the assignment indexes indicates a size of the HARQ-ACK information to be received from the communication device, and
wherein the assignment indexes are associated with the multicast service and a unicast service.

9. The method of claim 8,
wherein the set of information includes unicast information and multicast information that are respectively scheduled by a unicast control information and a multicast control information,
wherein the assignment indexes include a first assignment index for the unicast service and a second assignment index for the unicast service,
wherein the assignment indexes include a third assignment index for the multicast service and a fourth assignment index for the multicast service,
wherein the first assignment index and the second assignment index are associated with the unicast control information scrambled with a cell radio network temporary identifier (C-RNTI),
wherein each of the third assignment index and the fourth assignment index is associated with the multicast control information scrambled with one group radio network temporary identifier (G-RNTI) group, and
wherein the one G-RNTI group includes one or more G-RNTIs.

10. The method of claim 8,
wherein the set of information includes a first set of multicast information and a second set of multicast information that are respectively scheduled by the first multicast control information and the second multicast control information,
wherein the assignment indexes include a first assignment index for the multicast service and a second assignment index for the multicast service,
wherein the first assignment index is associated with a first multicast control information that is scrambled with a first set of one or more group radio temporary identifiers (G-RNTIs) from a first G-RNTI group, and
wherein the second assignment index is associated with a second multicast control information that is scrambled with a second set of one or more G-RNTIs from a second G-RNTI group.

11. The method of claim 9, wherein the network device transmits a radio resource control (RRC) signal that configures one or more G-RNTI groups, wherein each G-RNTI group includes a unique set of one or more G-RNTIs.

12. The method of claim 8,
wherein the set of information includes unicast information that is scheduled by a unicast control information,
wherein the set of information includes multicast information that is scheduled by a first multicast control information and a second multicast control information,
wherein the assignment indexes include a first assignment index that is shared by the unicast service and the multicast service and a second assignment index for the multicast service,
wherein the first assignment index is associated or shared with the unicast control information scrambled with a cell radio network temporary identifier (C-RNTI) and with the first multicast control information scrambled with a first set of one or more group radio network temporary identifiers (G-RNTIs) from a first G-RNTI group, and
wherein the second assignment index is associated or shared with the unicast control information scrambled with the C-RNTI and with the second multicast control information scrambled with a second set of one or more G-RNTIs from a second G-RNTI group.

13. The method of claim 8,
wherein a value of an assignment index from the assignment indexes is equal to mod(max(Xᵣₙₜᵢ)−1,4)+1,
wherein Xᵣₙₜᵢ is a number of pairs of serving cell and control channel monitoring occasion for a corresponding RNTI.

14. The method of claim 8,
wherein a value of an assignment index from the assignment indexes is equal to max(V_{T-DAI}^{rnti}),
wherein V_{T-DAI}^{rnti} is a value of an assignment index in a last downlink control information (DCI) which indicates to provide feedback in a slot for the corresponding RNTI.

15. An apparatus for wireless communication comprising a processor, configured to implement a method, the processor configured to:
receive, by a communication device, a control information that indicates that a set of information is to be received by the communication device using a multicast service; and
transmit, by the communication device, hybrid automatic repeat request (HARQ) acknowledgement (ACK) information in a shared channel,
wherein the HARQ-ACK information indicates whether the set of information is received or correctly decoded by the communication device,
wherein the HARQ-ACK information is generated using assignment indexes included in the control information received by the communication device,
wherein each of the assignment indexes indicates a size of the HARQ-ACK information to be transmitted by the communication device, and
wherein the assignment indexes are associated with the multicast service and a unicast service.

16. The apparatus of claim 15,
wherein the set of information includes unicast information and multicast information that are respectively scheduled by a unicast control information and a multicast control information,
wherein the assignment indexes include a first assignment index for the unicast service and a second assignment index for the unicast service,
wherein the assignment indexes include a third assignment index for the multicast service and a fourth assignment index for the multicast service,
wherein the first assignment index and the second assignment index are associated with the unicast control information scrambled with a cell radio network temporary identifier (C-RNTI),
wherein each of the third assignment index and the fourth assignment index is associated with the multicast control information scrambled with one group radio network temporary identifier (G-RNTI) group, and
wherein the one G-RNTI group includes one or more G-RNTIs.

17. The apparatus of claim 15,
wherein the set of information includes a first set of multicast information and a second set of multicast information that are respectively scheduled by the first multicast control information and the second multicast control information,
wherein the assignment indexes include a first assignment index for the multicast service and a second assignment index for the multicast service,
wherein the first assignment index is associated with a first multicast control information that is scrambled with a first set of one or more group radio temporary identifiers (G-RNTIs) from a first G-RNTI group, and
wherein the second assignment index is associated with a second multicast control information that is scrambled with a second set of one or more G-RNTIs from a second G-RNTI group.

18. An apparatus for wireless communication comprising a processor, configured to implement a method, the processor configured to:
transmit, by a network device, a control information that indicates that a set of information is to be transmitted to a communication device using a multicast service; and
receive, by the network device, hybrid automatic repeat request (HARQ) acknowledgement (ACK) information in a shared channel,
wherein the HARQ-ACK information indicates whether the set of information is received or correctly decoded by the communication device,
wherein the HARQ-ACK information is based on assignment indexes included in the control information transmitted to the communication device,
wherein each of the assignment indexes indicates a size of the HARQ-ACK information to be received from the communication device, and
wherein the assignment indexes are associated with the multicast service and a unicast service.

19. The apparatus of claim 18,
wherein the set of information includes unicast information and multicast information that are respectively scheduled by a unicast control information and a multicast control information,
wherein the assignment indexes include a first assignment index for the unicast service and a second assignment index for the unicast service,
wherein the assignment indexes include a third assignment index for the multicast service and a fourth assignment index for the multicast service,
wherein the first assignment index and the second assignment index are associated with the unicast control information scrambled with a cell radio network temporary identifier (C-RNTI),
wherein each of the third assignment index and the fourth assignment index is associated with the multicast control information scrambled with one group radio network temporary identifier (G-RNTI) group, and
wherein the one G-RNTI group includes one or more G-RNTIs.

20. The apparatus of claim 18,
wherein the set of information includes a first set of multicast information and a second set of multicast information that are respectively scheduled by the first multicast control information and the second multicast control information,
wherein the assignment indexes include a first assignment index for the multicast service and a second assignment index for the multicast service,
wherein the first assignment index is associated with a first multicast control information that is scrambled with a first set of one or more group radio temporary identifiers (G-RNTIs) from a first G-RNTI group, and
wherein the second assignment index is associated with a second multicast control information that is scrambled with a second set of one or more G-RNTIs from a second G-RNTI group.
